(19) United States
(12) Patent Application Publication
(10) Pub. No.: US 2021/0146269 A1
(43) Pub. Date: May 20, 2021

(54) COLOURED SLIMYSAND AND PREPARATION METHOD THEREOF

(71) Applicant: Christina Mao, Ningbo (CN)

(72) Inventor: Christina Mao, Ningbo (CN)

(21) Appl. No.: 16/745,357

(22) Filed: Jan. 17, 2020

(30) Foreign Application Priority Data
Nov. 18, 2019 (CN) 201911124860.5

(51) Int. Cl. A63H 33/00

(52) U.S. Cl. CPC A63H 33/001

(57) ABSTRACT

The invention discloses a coloured slimysand comprising following raw materials in percentage by weight: 70%-88% of silicon dioxide, 5%-10% of water, 1%-5% of phenyl silicone oil, 1%-3% of mannitol, 1%-5% of white granulated sugar, 2%-10% of adhesive, 0.2%-1.3% of preservative, and 0.1%-0.5% of pigment, wherein silicon dioxide selected is penetrating porous one after smoothing treatment. The preparation method is: preparing raw materials; sieving silicon dioxide, soaking in clean water, transferring to the container, and colouring silicon dioxide by prepared pigment solution via hyperbaric spraying, to be used after drying; adding water, white granulated sugar and adhesive to the container, stirring while heating until all are dissolved and transparent, then adding coloured silicon dioxide, stirring well, and cooling to below 50° C.; adding phenyl silicone oil, mannitol and preservative, mixing well and cooling, obtaining coloured slimysand, featuring light weight, safe use, good moisturizing property and strong tensile capacity.

### BACKGROUND OF THE INVENTION

### 1. Field of the Invention

The invention relates to a slimysand, specifically relating to a coloured slimysand and its preparation method.

### 2. Description of the Related Art

The toy slimysand, characterized in plasticity, reducibility, and durability, is an intelligence toy favored by children and can help foster their creativity and manipulative ability.

Currently, the adhesive of the toy slimysand sold in the market is produced by cross-linking reaction between boron and silicone oil, but boron is so harmful to the body that it poses serious health hazard to children's physical fitness. Current slimysand exists defects of heavy weight and poor moisturizing property in that it will crack and can not work properly after being stored for a period due to water loss. Accordingly, current slimysand needs further improvement.

### SUMMARY OF THE INVENTION

To overcome the shortcomings of the current technology, the invention provides a coloured slimysand with light weight, great moisturizing property and strong tensile capacity, which is simple in preparation and low in production cost.

The invention employs the following technical plan to solve above technical problem:

A coloured slimysand comprising following raw materials in percentage by weight:

| | |
|---|---|
| silicon dioxide | 70%-88% |
| water | 5%-10% |
| phenyl silicone oil | 1%-5% |
| mannitol | 1%-3% |
| white granulated sugar | 1%-5% |
| adhesive | 2%-10% |
| preservative | 0.2%-1.3% |
| pigment | 0.1%-0.5% |

Said silicon dioxide selected is penetrating porous one after smoothing treatment.

The particle size of said silicon dioxide is in 80-120 mesh.

Said preservative is the mixture of two or more of phenoxyethanol, caprylyl glycol, ethylhexylglycerin, sodium dehydroacetate, and sodium ethylparaben.

Said adhesive is the mixture of two or more of polyvinyl alcohol, polyacrylamide, polyvinyl acetate and polyvinylpyrrolidone.

A method to prepare coloured slimysand comprising following steps:

Step 1 [symbol] preparing raw materials;

Step 2 [symbol] sieving silicon dioxide, soaking the sieved silicon dioxide in clean water, transferring it to the container, and colouring silicon dioxide by prepared pigment solution via hyperbaric spraying, to be used after drying;

Step 3 [symbol] adding water, white granulated sugar and adhesive in sequence to the container, stirring at the time of heating until they are all dissolved and transparent, then adding coloured silicon dioxide, stirring well, and cooling to below 50° C.;

Step 4 [symbol] adding phenyl silicone oil, mannitol and preservative, mixing well and cooling, then obtaining the coloured slimysand.

The time for soaking said silicon dioxide is at least half an hour.

Compared with prior art, the invention has following merits: the silicon dioxide selected is penetrating porous one after going through smoothing treatment, which can not only reduce the weight of the slimysand, but also increase surface area of contact surface between the porous silicon dioxide and the adhesive, thus remarkably increasing adhesion of the adhesive. While the silicon dioxide after going through smoothing treatment, the surface area of contact surface among particles is smaller and the particles are not prone to accumulate. The mannitol and white granulated sugar have strengthened stringiness of the adhesive and further improved tensile capacity of the slimysand. The adding of mannitol can increase moisturizing property and the phenyl silicone oil solved the drawback of heavy and sticky feeling of hand existing in traditional silicone oil. The invention is simple in preparation and low in production cost.

### DETAILED DESCRIPTION OF THE PREFERRED EMBODIMENTS

The invention is further described in detail hereinafter with reference to the embodiments.

A coloured slimysand comprising following raw materials in percentage by weight:

| | |
|---|---|
| silicon dioxide | 70%-88% |
| water | 5%-10% |
| phenyl silicone oil | 1%-5% |
| mannitol | 1%-3% |
| white granulated sugar | 1%-5% |
| adhesive | 2%-10% |
| preservative | 0.2%-1.3% |
| pigment | 0.1%-0.5% |

Said silicon dioxide selected is penetrating porous one after going through smoothing treatment and can be purchased on the market directly. Using penetrating porous silicon dioxide can not only reduce the weight of the slimysand, but also increase surface area of contact surface between the silicon dioxide and the adhesive, thus remarkably increasing adhesion of the adhesive; Adding mannitol and white granulated sugar in ingredients have strengthened stringiness of the adhesive and further improve tensile capacity of the slimysand, which can reduce the risk of slimysand's braking in the process of stretching and enhance fun of playing. The adding of mannitol can increase moisturizing property of the slimysand.

The pigment adopted is blue No. 1, yellow No. 5, and red No. 40 and other FDA approved pigment.

The particle size of said silicon dioxide is in 80-120 mesh.

Said adhesive is the mixture of two or more of polyvinyl alcohol, polyacrylamide, polyvinyl acetate and polyvinylpyrrolidone.

As the mixture of two or more of said elements, said adhesive has combined features, advantages and disadvantages of different adhesive to achieve better effect, among which the mixture of polyvinyl alcohol and polyacrylamide is preferred.

Said preservative is the mixture of two or more of phenoxyethanol, caprylyl glycol, ethylhexylglycerin, sodium dehydroacetate, and sodium ethylparaben.

As the mixture of two or more of said elements, said preservative has combined features, advantages and disadvantages of different preservative to achieve better effect, among which the mixture of phenoxyethanol and caprylyl glycol is preferred.

A method to prepare coloured slimysand comprising following steps:

Step 1 [symbol] preparing raw materials;

Step 2 [symbol] sieving silicon dioxide, soaking the sieved silicon dioxide in clean water for at least half an hour, transferring it to the container, and colouring silicon dioxide by prepared pigment solution via hyperbaric spraying, to be used after drying;

Step 3 [symbol] adding water, white granulated sugar and adhesive in sequence to the container, stirring at the time of heating until they are all dissolved and transparent, then adding coloured silicon dioxide, stirring well, and cooling to below 50° C.;

Step 4 [symbol] adding phenyl silicone oil, mannitol and preservative, mixing well and cooling, then obtaining the coloured slimysand.

The invention is further described in detail hereinafter with reference to the embodiment.

### Embodiment 1

Preparing following raw materials in percentage by weight:

| | |
|---|---|
| penetrating porous silicon dioxide | 72%; |
| after smoothing treatment | |
| water | 10%; |
| phenyl silicone oil | 1%; |
| mannitol | 3%; |
| white granulated sugar | 5%; |
| polyvinyl alcohol | 1.1%; |
| polyacrylamide | 6.5%; |
| phenoxyethanol | 0.8%; |
| caprylyl glycol | 0.1%; |
| pigment | 0.5%. |

Preparation process:

Step 1 [symbol] preparing raw materials;

Step 2 [symbol] sieving silicon dioxide with a sieve of 80-120 mesh, soaking the sieved silicon dioxide in clean water for at least half an hour, transferring it to the container, and colouring silicon dioxide by prepared pigment solution via hyperbaric spraying, to be used after drying;

Step 3 [symbol] adding water, white granulated sugar and adhesive(polyvinyl alcohol and polyacrylamide) in sequence to the container, stirring at the time of heating until they are all dissolved and transparent, then adding coloured silicon dioxide, stirring well, and cooling to below 50° C.;

Step 4 [symbol] adding phenyl silicone oil, mannitol and preservative (phenoxyethanol and caprylyl glycol), mixing well and cooling, then obtaining the coloured slimysand.

### Embodiment 2

Preparing following raw materials in percentage by weight:

| | |
|---|---|
| penetrating porous silicon dioxide | 80%; |
| after smoothing treatment | |
| water | 5%; |
| phenyl silicone oil | 4%; |
| mannitol | 2%; |
| white granulated sugar | 3%; |
| polyvinyl alcohol | 3%; |
| polyvinyl acetate | 2.1%; |
| phenoxyethanol | 0.5%; |
| ethylhexylglycerin | 0.1%; |
| pigment | 0.3%. |

Step 1 [symbol] preparing raw materials;

Step 2 [symbol] sieving silicon dioxide with a sieve of 80-120 mesh, soaking the sieved silicon dioxide in clean water for at least half an hour, transferring it to the container, and colouring silicon dioxide by prepared pigment solution via hyperbaric spraying, to be used after drying;

Step 3 [symbol] adding water, white granulated sugar and adhesive (polyvinyl alcohol and polyvinyl acetate) in sequence to the container, stirring at the time of heating until they are all dissolved and transparent, then adding coloured silicon dioxide, stirring well, and cooling to below 50° C.;

Step 4 [symbol] adding phenyl silicone oil, mannitol and preservative (phenoxyethanol and ethylhexylglycerin), mixing well and cooling, then obtaining the coloured slimysand.

### Embodiment 3

Preparing following raw materials in percentage by weight:

| | |
|---|---|
| penetrating porous silicon dioxide | 81%; |
| after smoothing treatment | |
| water | 6%; |
| phenyl silicone oil | 2%; |
| mannitol | 3%; |
| white granulated sugar | 1%; |
| polyvinylpyrrolidone | 1%; |
| polyacrylamide | 5%; |
| sodium dehydroacetate | 0.5%; |
| caprylyl glycol | 0.2%; |
| pigment | 0.3%. |

### Embodiment 4

Preparing following raw materials in percentage by weight:

| | |
|---|---|
| penetrating porous silicon dioxide | 82%; |
| after smoothing treatment | |
| water | 7%; |
| phenyl silicone oil | 2%; |
| mannitol | 1.5%; |
| white granulated sugar | 1.5%; |
| polyvinyl alcohol | 2%; |
| polyvinylpyrrolidone | 1%; |
| polyacrylamide | 2%; |
| phenoxyethanol | 0.4%; |
| caprylyl glycol | 0.3%; |
| pigment | 0.3%. |

### Embodiment 5

Preparing following raw materials in percentage by weight:

| | |
|---|---|
| penetrating porous silicon dioxide | 78%; |
| after smoothing treatment | |
| water | 10%; |
| phenyl silicone oil | 2%; |
| mannitol | 2%; |
| white granulated sugar | 2%; |
| polyvinyl acetate | 2.3%; |
| polyvinylpyrrolidone | 2.3%; |
| sodium ethylparaben | 0.4%; |
| ethylhexylglycerin | 0.3%; |
| caprylyl glycol | 0.4%; |
| pigment | 0.3% |

The invention and its preferred embodiments have been described above. It is to be understood by those skilled in the art that non-creative design of structural forms and embodiments that are similar to the technical solutions without departing from the spirit of the invention shall all fall within the protective scope of the invention.

1. A coloured slimysand wherein it comprises following raw materials in percentage by weight:

| | |
|---|---|
| silicon dioxide | 70%-88% |
| water | 5%-10% |
| phenyl silicone oil | 1%-5% |
| mannitol | 1%-3% |
| white granulated sugar | 1%-5% |
| adhesive | 2%-10% |
| preservative | 0.2%-1.3% |
| pigment | 0.1%-0.5% |

Said silicon dioxide selected is penetrating porous one after going through smoothing treatment.

2. A coloured slimysand according to claim 1 wherein the particle size of said silicon dioxide is in 80-120 mesh.

3. A coloured slimysand according to claim 1 wherein said adhesive is the mixture of two or more of polyvinyl alcohol, polyacrylamide, polyvinyl acetate and polyvinylpyrrolidone.

4. A coloured slimysand according to claim 1 wherein said preservative is the mixture of two or more of phenoxyethanol, caprylyl glycol, ethylhexylglycerin, sodium dehydroacetate, and sodium ethylparaben.

5. A method to prepare coloured slimysand according to claim 1 wherein it comprises following steps:
Step 1 [symbol] preparing raw materials;
Step 2 [symbol] sieving silicon dioxide, soaking the sieved silicon dioxide in clean water, transferring it to the container, and colouring silicon dioxide by prepared pigment solution via hyperbaric spraying, to be used after drying;
Step 3 [symbol] adding water, white granulated sugar and adhesive in sequence to the container, stirring at the time of heating until they are all dissolved and transparent, then adding coloured silicon dioxide, stirring well, and cooling to below 50° C.;
Step 4 [symbol] adding phenyl silicone oil, mannitol and preservative, mixing well and cooling, then obtaining the coloured slimysand.

6. A method to prepare coloured slimysand according to claim 5 wherein the time for soaking said silicon dioxide is at least half an hour.
